(19) United States
(12) Patent Application Publication
(10) Pub. No.: US 2015/0308216 A1
(43) Pub. Date: Oct. 29, 2015

(54) FIBER REINFORCED SEALING ELEMENT

(71) Applicant: HALLIBURTON ENERGY SERVICES INC., Houston, TX (US)

(72) Inventors: Matthew Hassett Wiggins, Spring, TX (US); Christopher Alan Grace, Coppell, TX (US)

(73) Assignee: HALLIBURTON ENERGY SERVICES INC., Houston, TX (US)

(21) Appl. No.: 14/650,185

(22) PCT Filed: Mar. 12, 2013
(86) PCT No.: PCT/US2013/030550

§ 371 Date: Jun. 5, 2015

(51) Int. Cl. E21B 33/12; B29C 45/72; B29C 45/00

(52) U.S. Cl. CPC E21B 33/1208; B29C 45/0005; B29C 45/72; B29C 2045/0006; B29C 2045/0008; B29K 2075/00

(57) ABSTRACT

A method for making a sealing element for a rotating control device used in rotary drilling systems is disclosed. The sealing element has a bore, a base region, and a nose region. The method comprises providing a mold for the sealing element for the rotating control device, adding fibers at a first concentration to a first liquid elastomer material containing polyurethane, placing the first liquid elastomer material having a first concentration of fibers into the mold, adding fibers at a second concentration to a second liquid elastomer material containing polyurethane, placing the second liquid elastomer material having a second concentration of fibers into the mold, heating the fibers and liquid elastomer in the mold, and forming a sealing element having a bore, a base region with a first concentration of fibers, and a nose region having a second concentration of fibers.

### TECHNICAL FIELD

This disclosure relates generally to a sealing element for a rotating control device (RCD) used in rotary drilling systems, and particularly to a fiber reinforced sealing element for the RCD.

### BACKGROUND

During drilling, an earth-boring drill bit is typically mounted on the lower end of a drill string and is rotated to form a wellbore by rotating the drill string. During this process erratic pressures and uncontrolled flow known as formation “kick” pressure surges can emanate from a well reservoir, potentially causing a catastrophic blowout. Because formation kicks are unpredictable and would otherwise result in disaster, flow control devices known as blowout preventers (“BOPs”) are required on most wells drilled today. BOPs are often installed redundantly in stacks, and are used to seal, control and monitor oil and gas wells.

One common type of BOP is an annular blowout preventer Annular BOPs are configured to seal the annular space between the drill string and the wellbore annulus. Annular BOPs are typically generally toroidal in shape and are configured to seal around a variety of drill string sizes, or alternatively around non-cylindrical objects such as a polygon-shaped Kelly drive. Drill strings formed of drill pipes connected by larger-diameter connectors can be threaded through an annular BOP Annular BOPs are not designed to be stationary while maintaining a seal around the drill string as it rotates during drilling because rotating the drill string through an annular BOP would rapidly wear it out, causing the blowout preventer to be less capable of sealing the well.

In some drilling operations, a rotating control device (RCD) located on top of the BOP stack is used in managed pressure and underbalanced drilling to interface between high and low pressure regions of drilling operations. During this type of drilling the well bore is held at pressures that are well above atmosphere which creates the problem of how to get the drill pipe into the well without the loss of well pressure and fluid. The RCD forms a seal between the well bore and the drill pipe so that the drill string can move vertically and rotationally without the loss of well pressure.

The key component in the RCD, which allows for the separation of high and low pressure regions, is the RCD sealing element. The RCD sealing element is comprised of a core and an elastomeric body. The core is molded into the upstream end of the elastomeric body and is used to fasten the element to the RCD. Cores can be made in many shapes and sizes and fabricated from many materials. For example, an RCD core can be made from steel and is referred to as a cage. An RCD sealing element may also be referred to as a stripper rubber.

A drill string of varying diameter is passed through the center of an RCD sealing element. RCD sealing elements are currently made so that the inside diameter of the RCD sealing element is smaller than the smallest outside diameter of any part of the drill string passed through it. As the various parts of the drill string move longitudinally through the interior of the stripper rubber a seal is continuously maintained.

RCD sealing elements seal around rough and irregular surfaces such as those found on a drill string and are subjected to conditions where strength and resistance to wear are very important characteristics. However, RCD sealing elements often have a short life expectancy, especially when they are used in wells that have high well bore pressures. Loads exerted on the outside of the element body by the high pressure region of the well cause the element to deform and press against the drill pipe. High frictional loads result from the pipe being stripped through the element as it is deformed against the drill pipe. High pressures in the well can accelerate RCD sealing element failure. Common modes of RCD sealing element failure include side wall blow through, vertical and horizontal cracking and chunking away of the interior region of the sealing element body also known as “nibbing”.

Conventional prior art sealing elements in rotating control devices (RCDs) tend to split or experience chunking when encountering harsh loading conditions due to poor tear resistance. Further, over time the sealing element may become worn and may become unable to substantially deform to provide a seal around the drill string. Consequently, the sealing element must be replaced, which may lead to down time during drilling operations that can be costly to a drilling operator.

### DESCRIPTION OF DRAWINGS

The details of one or more embodiments of the disclosure are set forth in the accompanying drawings and the description below.

FIG. 1 is a cross sectional view of a rotating control device.

FIG. 2 is a cross sectional view of a rotating control device sealing element in the rotating control device of FIG. 1.

FIG. 3 is a schematic view of a fiber-reinforced elastomer to be used in a rotating control device sealing element.

FIG. 4 is a cross sectional view of a rotating control device sealing element comprising a fiber-reinforced elastomer.

FIG. 5 is a cross sectional view of a rotating control device sealing element comprising fiber-reinforced elastomers of varying fiber concentration.

### DETAILED DESCRIPTION

In the rotating control device (RCD) sealing element of the present disclosure the body comprises the majority of an RCD device and is the component responsible for creating a seal between the drill pipe threaded through the RCD and the interior of the wellbore below the RCD. Materials for making the elastomeric body include polyurethane, natural rubber, nitrile rubber and butyl rubber. In use, the RCD sealing element is held inside the RCD and the drill pipe stabs through the RCD sealing element when it enters the RCD, creating an interfacial seal capable of separating the high pressure region of the well bore from the atmospheric pressure region of the rig floor. The interfacial seal is created when the drill pipe enters the RCD sealing element and deforms the inner diameter of the RCD sealing element to fit over the larger diameter of the drill pipe. While attached, the drill pipe penetrating the RCD sealing element is capable of vertical motion as well as rotational motion. The RCD sealing element is also able to expand to fit over tool joints as new sections of drill pipe are added to the drill string.

This disclosure also relates to a method of improving the material properties of the elastomeric RCD element body by introducing a fibrous reinforcing material into the elastomer. During the preparation of the elastomer raw material, fibers can be added so that the performance characteristics of the finished element are altered. Elements that have been molded with reinforced elastomer can have improved strength, resistance to tear and abrasion while still exhibiting good elongation.

The elastomer used to form the RCD sealing element of the present invention contains polyurethane. Rubber and polyurethane do not have identical material properties. Natural rubber has excellent elastic memory, that is it will return its original shape after being compressed or stretched. Polyurethane has a substantially lower memory than rubber. Compression Set is a measure of memory. In one implementation, the polyurethane described herein has a compression set of approximately 62% while rubber compounds can have a compression set of 6% or lower. Polyurethane is affected by temperature differently than rubber. Polyurethane breaks down in the presence of water while remaining strong in the presence of oil, rubber is the opposite.

The molding process is significantly different between rubber and cast polyurethane; rubber is injected into a mold with high pressure and high temperature while cast urethane is simply poured into a mold and heated in an oven. Since the molding process is different the technique for adding reinforcing fibers is also different. Since, unlike with rubber molding the mold is not filled under high pressure, fibers can be connected to the inside of the empty mold and oriented horizontally, vertically, radially or in any combination desired prior to the filling of the mold. Concentration and placement of the reinforcing fibers in elastomers containing polyurethane can be carefully controlled, thus allowing regions of the element to be targeted with more reinforcing material and other regions to be given very little or no reinforcing material.

A major limitation to the capabilities of prior art RCDs is the amount of well pressure at which they can they can operate, with the capabilities of current RCD sealing elements as a major limiting factor. An advantage of the RCD of this disclosure is providing an RCD sealing element that can operate at higher pressures than current RCD sealing elements.

Often RCD sealing element life is short which can result in frequent element replacement during drilling operations. It is well-known that rig time can be very expensive, especially when drilling operations are performed in deep water. Typical deep water daily rig costs can range between $400,000 and $900,000 a day. If an RCD sealing element can last for drilling a complete borehole section, the approximate two hours rig time for an element change out equates to a rig downtime saving of $33,000 to $75,000. Improving element life with an element with improved life and durability according to this disclosure will reduce costs. This cost saving will be achieved by fewer elements being required to complete an operation, as well as saving in much more costly rig down time. Improving element life will also result in a reduction of nonproductive time for the rig since the rig must be shut down each time an element is changed out.

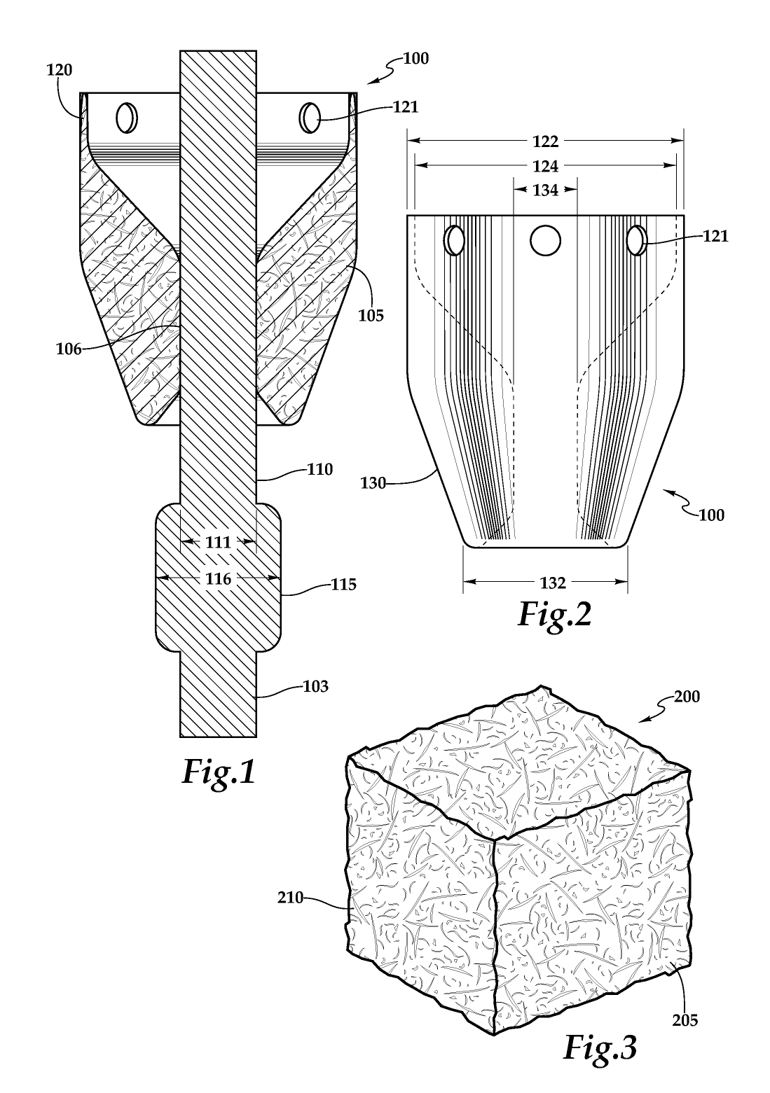

Referring to FIG. 1, one implementation of the RCD 100 includes an RCD sealing element 105 (also sometimes referred to in the art as a “stripper element” or “stripper rubber”). The RCD sealing element 105 acts as a passive seal that maintains a constant barrier between the atmosphere above and wellbore below. An interior surface 106 of the RCD sealing element 105 seals against a drill string 110. The drill string 110 extends from a drilling rig (not shown) through the sealing element 105 and into the wellbore (not shown).

A drill string typically includes multiple drill pipes connected by threaded connections located on both ends of the drill pipes. Although the threaded connections may be flush with outer diameter of the drill pipes, they generally have a wider outer diameter. For example, as shown in FIG. 1, drill string 110 is formed of a long string of threaded pipes 103 joined together with tool joints 115. The tool joints 115 have an outer diameter 116 that is larger than the outer diameter 111 of the pipes 103. As the drill string is longitudinally translated through the wellbore and the RCD 100, the RCD sealing element 105 squeezes against an outer surface of the drill string 110, thereby sealing the wellbore. In particular, the inner diameter of the RCD sealing element 105 is smaller than the outer diameter of the items passed through (e.g., drill pipes, tool joints) to ensure sealing.

A side view of an exemplary RCD sealing element 105 is shown in FIG. 2. The RCD sealing element 105 has a base end 120 and a nose end 130. The base end 120 is typically attached to a mandrel (not shown) running through the center of the bearing assembly, however it could also be attached to a stripper housing that does not include a bearing. The mandrel is attached to the bearing housing via two sets of bearings. The element is then screwed onto the mandrel or bolted to the mandrel; this allows the element to rotate with the drill string during drilling operations. For example, holes 121 are provided for set screws to lock the element to the mandrel once the element has been threaded onto the mandrel. However there are multiple other techniques used to mount the RCD sealing element to the RCD. This disclosure shall not be limited to this style of core but rather encompass all styles of core.

The nose end 130 has an inner diameter 134 that is smaller than the inner diameter of the base end 120 to provide a tight seal against the drill string 110. The outer diameter 122 of the base end 120 may be larger than the outer diameter 132 of the nose end 130. Similarly the inner diameter 124 of the base end 120 may be larger than the inner diameter 134 of the nose end 130.

Prior art RCD sealing elements are often made from of a single elastic material which is flexible enough to deform to fit around and seal the varying diameters. Sealing element material may include but not be limited to natural rubber, nitrile, butyl or polyurethane, for example, and depends on the type of drilling operation. The RCD sealing element 105 of the present disclosure is made from a polyurethane based elastomer and is flexible enough to deform to fit around and seal the varying diameters of drill pipe 110 (e.g., diameters 11 land 116 shown in FIG. 1).

To alter the performance characteristics of various RCD sealing element body materials, the addition of reinforcing fibers of many kinds and sizes may be used. Fibers may include but are not limited to cotton, polyester, glass fiber and polyvinyl alcohol (PVA). Fibers may be of varying deniers and lengths and may be combined in any combination of denier and length. For example, an elastomer may be reinforced with fibers of uniform length and varying denier or an elastomer may be reinforced with fibers of varying length and uniform denier. Any combination of length and dernier is permissible. In one embodiment, fibers may have a length of ⅛″ to 5″ and a denier of 1200 to 1800.

As shown in FIG. 3, reinforcing fibers 205 can be added to the elastomer raw material 210 to form a resultant composite material 200. This composite material 200 can be comprised of both uniformly distributed fibers and non-uniformly distributed fibers. Fibers 205 can be randomly oriented, or may be non-randomly oriented (i.e., oriented radially, oriented longitudinally, or oriented at some other angle or combination of angles).

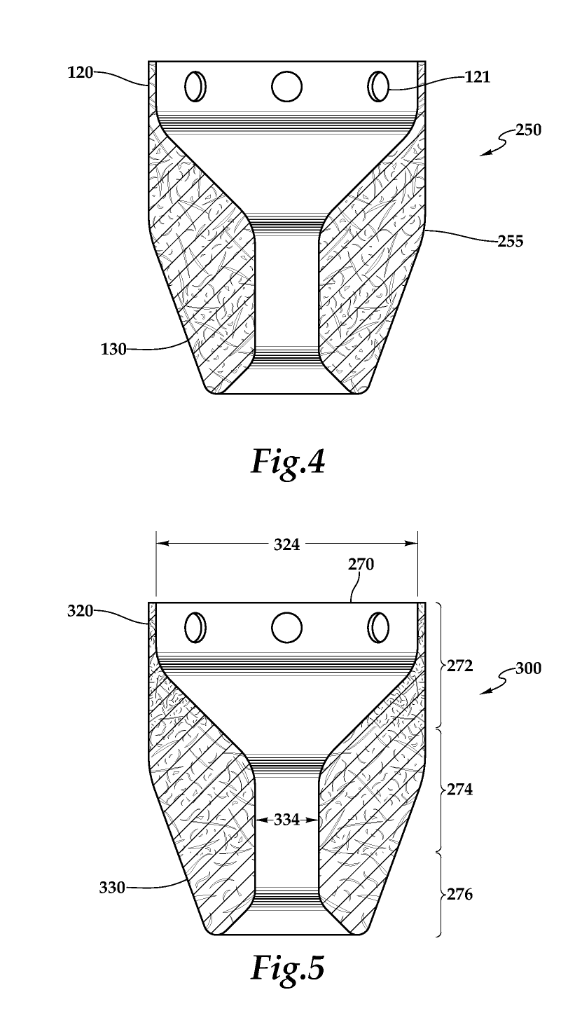

The concentration of reinforcement fibers 205 within the elastomer material 210 can be varied to alter the properties of the composite material 210, allowing for the customization of element material properties. For example, as shown in FIG. 4, an RCD sealing element 250 may be molded with an elastomer that has a uniform concentration 255 of fibers throughout. Any fiber concentration is permissible, although fiber concentration ranging from 1% to 20% is preferred. Element properties that will be altered by the addition of reinforcing fibers include but are not limited to the following: tensile strength, elongation, stress-strain modulus, tear strength, compression set and Taber abrasion.

Alternatively, an RCD sealing element may be molded with an elastomer material that has a non-uniform concentration of reinforcing fibers along the length (i.e., along a longitudinal or axial axis) of the RCD sealing element. For example, shown in FIG. 5, an RCD sealing element 270 has a higher concentration of reinforcement fibers at its base 320 and a lower concentration of fibers at its nose 330. Any combination of fiber concentration is permissible. For example, more than two concentrations (i.e., three different fiber concentrations) are shown in FIG. 5: a region with high concentrations of fiber reinforcement 272, a region with moderate concentrations of fiber reinforcement 274 and a region with low concentrations of fiber reinforcement 276.

In a varying fiber concentration RCD sealing element 270, each region of fiber reinforced element material exhibits material properties are different from the other regions. The particular material properties can be selected to optimize performance of different regions of the RCD sealing element 270. For example, resistance to pressure is a critical material property needed at the base end 320. Additional tensile and compressive strength near is required near the base end 320 for resisting the tendency of the RCD sealing element 270 to blow out when high pressure builds on the exterior surface of the RCD sealing element 270. To increase strength, a high concentration of fibers 272 is used in the base end 320 of the RCD sealing element 270. Resistance to deformation resulting from external pressure is also essential to the long life of RCD sealing element 270. Since the inner diameter at the base end 320 is much larger than the ID at the nose end 330 the amount of elongation required at the base end 320 is much less than the amount of elongation required at the nose end 330. Since high elongation is not required in the base section 320 a higher concentration of fibers can be used, for example 20%, thus giving increased strength and wear resistance. In the middle section 274 moderate elongation is required so a concentration of approximately 5-10% may be used to increase strength and wear resistance while allowing for required elongation. In the nose section 276 where the greatest elongation is required and wear resistance is less important a lower concentration of approximately 1-5% can be used.

The nose end 330 of the RCD sealing element 270 requires greater flexibility in order for the smaller inner diameter 334 of the nose end 330 (compared to the wider diameter 324 of the base end 320) to deform around the diameters of the wellbore components passed through (e.g., drill pipe diameter 111, tool joint diameter 116). Lower concentration fibers 276 enhance wear resistance but still allow deformation or elongation. Preferably the fibers in the nose area 272 have a concentration 276 ranging between about 1% to 20%. The result is an the RCD sealing element 270 which has a higher resistance to pressure as well as longer wear in the area that contacts the wellbore components.

In one embodiment, fibers are added to the liquid polyurethane and the mixture poured into the mold results in a uniform distribution of fibers with random orientation.

In another embodiment, the fibers are longitudinally suspended from the top of the mold so that they hang down throughout the length of the element running parallel to the central axis of the element. When the mold is filled the polyurethane will fill in around the suspended fibers and cure with the fibers inside of the element.

In a further embodiment the fibers are connected to the mold core and extended to the mold shell. This would orient the fibers in a radial direction. Again the mold would be filled and the polyurethane allowed to cure.

Another embodiment involves filling the mold with the liquid polyurethane and then inserting the fibers into the liquid with an insertion tool. Since the polyurethane is a highly viscous fluid when it is poured into the mold, a fiber could be inserted and once released it would stay in the location it was deposited. Fibers could be inserted in any orientation and concentration desired.

To fabricate an RCD sealing element of the present disclosure one or more raw elastomer materials 210 is prepared. Once prepared, the elastomer is molded around a core to form a complete RCD sealing element. The element is made from cast polyurethane which uses a mold with a core. The core is used to form the ID of the element. The RCD sealing element has a steel cage or core molded into its base. RCD sealing elements can be molded using a single reinforced elastomer, or using multiple combinations of elastomers with various levels of reinforcement, or no reinforcement at all. For example, an element may be molded with a highly reinforced region at its base which transitions into a region of low reinforcement in its middle which transitions into a region of no reinforcement at its nose. Likewise, elements may be molded with various combinations of elastomer with the same amount of reinforcement. For example, an element may be molded with a region of low durometer elastomer and a region of high durometer elastomer, both with equal amounts of reinforcement. Any combination of elastomer and reinforcement is permissible.

In the implementation of this disclosure, the base material in the elastomer being used to mold an RCD sealing element is primarily polyurethane. Polyurethane may be used in any combination with natural rubber, nitrile, or butyl. Polyurethane is a flexible elastomer that can be stretched over the changing outer diameter of drill pipe and tool joints. To form an RCD sealing element of the current disclosure, the polyurethane is cast by pouring polyurethane in a liquid state into a mold.

To create an RCD sealing element with uniform fiber reinforcement, reinforcing fibers 205 are mixed into the liquid state polyurethane. The polyurethane-fiber mixture is poured into the mold. Heat and time are then applied to allow the material to set by heating in a curing oven. To create an element with targeted regions of fiber reinforcement multiple batches of liquid polyurethane with different levels of fiber reinforcement are mixed. When filling the RCD sealing element cast, the appropriate mixture of polyurethane would be used to fill the portion of the cast that is being target for a specific level of reinforcement.

Although embodiments of the present disclosure have been described as having at least two separate portions, wherein each separate portion has a different fiber reinforcing concentration, it is also within the scope of the present disclosure for the at least two elastomer materials to partially mix. Approximately a 0.5″-1″ region of mixing can exist between layers. In some embodiments the region of mixing can be about 0.25″ to about 0.5″. Alternatively, the region that experiences mixing could be increased.

A number of embodiments of the disclosure have been described. Nevertheless, it will be understood that various modifications may be made without departing from the spirit and scope of the disclosure. Accordingly, other embodiments are within the scope of the following claims.

1. A method for making a sealing element for a rotating control device used in rotary drilling systems, said sealing element having a bore, a base region, and a nose region, said method comprising:
providing a mold for the sealing element for the rotating control device;
adding fibers at a first concentration to a first liquid elastomer material containing polyurethane;
placing the first liquid elastomer material having a first concentration of fibers into the mold;
adding fibers at a second concentration to a second liquid elastomer material containing polyurethane;
placing the second liquid elastomer material having a second concentration of fibers into the mold;
heating the fibers and liquid elastomer in the mold; and
forming a sealing element having a bore, a base region with a first concentration of fibers, and a nose region having a second concentration of fibers.

2. The method of claim 1, further comprising placing an elastomer material having a third concentration of fibers into the mold.

3. The method of claim 1, further comprising selecting fibers from the group consisting of polyvinyl alcohol (PVA), glass, cotton, or polyester.

4. The method of claim 1 further comprising selecting fibers of ⅛″-½″ in length and 1200-1800 denier.

5. The method of claim 1 comprising orienting the fibers in a random, horizontal, vertical or radial orientation, or any combination of these orientations.

6. The method of claim 1 further comprising suspending the fibers longitudinally from the top of the mold parallel to a central axis of the sealing element and extending to a bottom of the mold prior to placing the first and second liquid elastomer material in the mold.

7. The method of claim 1 further comprising suspending the fibers radially from a central core of the mold to an inner surface of an outer wall of the mold prior to placing the elastomer material in the mold.

8. The method of claim 1 further comprising inserting the fibers into the first and second liquid elastomer material with an insertion tool.

9. A sealing element for a rotating control device used in a rotary drilling system, comprising:
said sealing element molded from a polyurethane base elastomer and fibers mixed into the polyurethane base elastomer;
said sealing element having an inner surface which forms a bore extending axially through the sealing element;
a base region;
a nose region opposite from the base region, wherein the nose region has an inner diameter smaller than the inner diameter of an attachment region;
at least one region comprising a first concentration of fibers; and
at least one region comprising a second concentration of fibers.

10. The element of claim 9, wherein the first concentration is higher than the second concentration.

11. The element of claim 9, wherein the region comprising the first concentration of fibers is located near the base region of the sealing element.

12. The element of claim 9, wherein the first concentration of fibers is in the range of 1%-20% measured by weight of the elastomer and fiber composite.

13. The element of claim 9, wherein the fibers are randomly oriented in the sealing element.

14. The element of claim 9, wherein the fibers are uniformly distributed in the sealing element.

15. The element of any claim 9 wherein the fibers are ⅛″-½″ in length and 1200-1800 denier.

16. The element of claim 9 wherein the fibers are formed from one of the group consisting of polyvinyl alcohol (PVA), glass, cotton, and polyester.

17. A method for making a sealing element for a rotating control device used in rotary drilling systems, comprising:
providing a mold for the sealing element for the rotating control device;
adding fibers at a first concentration to a first liquid elastomer material containing polyurethane;
placing the first liquid elastomer material having a first concentration of fibers into the mold;
adding fibers at a second concentration to a second liquid elastomer material containing polyurethane;
placing the second liquid elastomer material having a second concentration of fibers into the mold;
heating the fibers and liquid elastomer in the mold;
forming a sealing element having a bore;
wherein the sealing element can stretch to receive a wellbore component in a longitudinal insertion through the bore;
wherein the fibers enhance a property of the sealing element for extending the service life of the sealing element, including at least one of increased resistance to outside pressure, increased resistance to wear, and increased strength; and
wherein the fibers are randomly oriented and uniformly distributed in the sealing element.

18. The method of claim 17, further comprising selecting the fibers from the group consisting of polyvinyl alcohol (PVA), glass, cotton, and polyester.

19. The method of claim 17, further comprising selecting fibers of ⅛″-½″ in length and 1200-1800 denier.
